(19) United States
(12) Patent Application Publication
(10) Pub. No.: US 2007/0230598 A1
(43) Pub. Date: Oct. 4, 2007

(54) OFDMA transmitter and method of transmitting OFDMA signals using compress-decompress modulation

(76) Inventor: Yi-Hsiu Wang, Palo Alto, CA (US)

Correspondence Address: Wilson & Ham;PMB: 348, 2530 Berryessa Road, San Jose, CA, 95132, US

(21) Appl. No.: 11/605,817

(22) Filed: Nov. 29, 2006

Related U.S. Application Data
(60) Provisional application No. 60/787,274, filed on Mar. 30, 2006.

(51) Int. Cl. H04K 1/10

(52) U.S. Cl. 375/260

(57) ABSTRACT

An Orthogonal Frequency Division Multiple Access (OFDMA) transmitter and method of transmitting OFDMA signals modulates outgoing data into compressed codes, which are temporarily stored in a data buffer. The compressed codes from the data buffer are then decompressed into corresponding modulation signals, which are used to produce time domain waveform for wireless transmission.

### CROSS REFERENCE TO RELATED APPLICATION

This application is entitled to the benefit of U.S. Provisional Patent Application Ser. No. 60/787,274 filed on Mar. 30, 2006, which is incorporated herein by reference.

### BACKGROUND OF THE INVENTION

Orthogonal Frequency Division Multiple Access (OFDMA) technology is getting very popular in modern communication systems since the OFDMA technology can efficiently support multiple mobile stations with limited bandwidth and easily provide Quality of Service (QoS). The OFDMA technology is a multiple access version of orthogonal frequency-division multiplexing (OFDM). OFDM is a modulation technique for data transmission based on frequency-division multiplexing (FDM), which uses different frequency channels to transmit multiple streams of data. In OFDM systems, a wide channel is divided into multiple narrow-band subcarriers, which allow orthogonal modulated streams of data to be transmitted in parallel on the subcarriers.

In OFDMA systems, multiple subscribers can simultaneously use different subcarriers. Thus, in an OFDMA system, multiple data bursts can be transmitted in the same time frame but allocated in different frequency subcarriers. In a conventional OFDMA transmitter, all outgoing data is sequentially encoded, interleaved, modulated and subcarrier-mapped to a data buffer. As an example, the outgoing data may be modulated using Quadrature Phase-shift Keying (QPSK), 16 level Quadrature Amplitude Modulation (16-QAM) or 64 level QAM (64-QAM). After the data is modulated and subcarrier-mapped to the data buffer, all the stored data for different subcarriers is sent to an inverse fast Fourier transformer to generate time domain waveform symbol by symbol.

A concern with the above conventional OFDMA system is that the system requires a significantly large data buffer to store all the modulation values according to subcarriers and time frames. The large size requirement of the data buffer significantly adds to the cost of the OFDMA transmitter and increases power consumption.

In view of this concern, there is a need for an OFDMA transmitter and method of transmitting OFDMA signals that does not require such a large data buffer, which would lower cost, as well as power consumption.

### SUMMARY OF THE INVENTION

An Orthogonal Frequency Division Multiple Access (OFDMA) transmitter and method of transmitting OFDMA signals modulates outgoing data into compressed codes, which are temporarily stored in a data buffer. The compressed codes from the data buffer are then decompressed into corresponding modulation signals, which are used to produce time domain waveform for wireless transmission. The use of compressed codes allows a smaller data buffer to be used in the OFDMA transmitter, which lowers cost and power consumption of the OFDMA transmitter.

An OFDMA transmitter in accordance with an embodiment of the invention comprises a compressing modulator, a data buffer and a decompressing modulator. The compressing modulator is configured to modulate outgoing data into m-bit compressed codes. Some of the m-bit compressed codes represent OFDMA modulation symbols. The data buffer is configured to temporarily store the m-bit compressed codes. The decompressing modulator is configured to decompress the m-bit compressed codes from the data buffer into corresponding n-bit modulation signals, where n is greater than m. Some of the n-bit modulation signals are digital values of the OFDMA modulation symbols. The n-bit modulation signals are used to produce time domain waveform for wireless transmission.

An OFDMA transmitter in accordance with another embodiment of the invention comprises an encoder, a compressing modulator, a data buffer, a decompressing modulator and an inverse fast Fourier transformer. The encoder is configured to encode outgoing data into encoded data. The compressing modulator is configured to modulate the encoded data into m-bit compressed codes. Some of the m-bit compressed codes represent OFDMA modulation symbols. The data buffer is configured to temporarily store the m-bit compressed codes. The decompressing modulator is configured to decompress the m-bit compressed codes from the data buffer into corresponding n-bit modulation signals, where n is greater than m. Some of the n-bit modulation signals are digital values of the OFDMA modulation symbols. The inverse fast Fourier transformer is configured to perform inverse fast Fourier transform on the n-bit modulation signals to produce time domain waveform for wireless transmission.

A method of transmitting OFDMA signals in accordance with an embodiment of the invention comprises modulating outgoing data into m-bit compressed codes, some of the m-bit compressed codes representing OFDMA modulation symbols, temporarily storing the m-bit compressed codes in a data buffer, and decompressing the m-bit compressed codes from the data buffer into corresponding n-bit modulation signals, where n is greater than m, some of the n-bit modulation signals being digital values of the OFDMA modulation symbols. The n-bit modulation signals are used to produce time domain waveform for wireless transmission.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 is a block diagram of a transmitter for an Orthogonal Frequency Division Multiple Access (OFDMA) system in accordance with an embodiment of the invention.

FIG. 2A is a constellation diagram for the Quadrature Phase-shift Keying (QPSK) modulation scheme.

FIG. 2B is a constellation diagram for the 16 level Quadrature Amplitude Modulation (16-QAM) scheme.

FIG. 2C is a constellation diagram for the 64 level Quadrature Amplitude Modulation (64-QAM) scheme.

FIG. 3 is a process flow diagram of a method of transmitting OFDMA signals in accordance with an embodiment of the invention.

### DETAILED DESCRIPTION

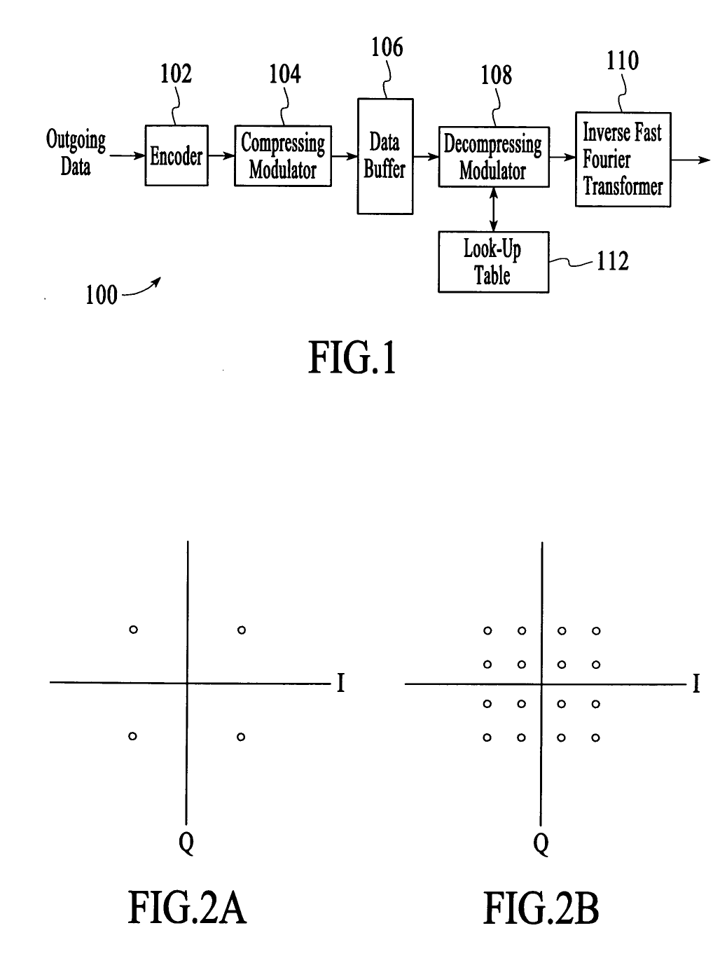

With reference to FIG. 1, a transmitter 100 for an Orthogonal Frequency Division Multiple Access (OFDMA) system in accordance with an embodiment of the invention is described. In particular, the OFDMA transmitter 100 is used in a base station that can wirelessly communicate with multiple mobile stations or is used in a mobile station to transfer multiple data and control bursts back to the base station. As described in more detail below, the OFDMA transmitter 100 is configured to perform modulation, which involves compression and decompression, on outgoing data so that the OFDMA transmitter can use a smaller data buffer than conventional OFDMA transmitters. The smaller data buffer for the OFDMA transmitter 100 translates into lower cost and reduced power consumption for the transmitter. This is particularly important for the mobile stations.

As shown in FIG. 1, the OFDMA transmitter 100 includes an encoder 102, a compressing modulator 104, a data buffer 106, a decompressing modulator 108 and an inverse fast Fourier transformer 110. The encoder 102 is connected to sequentially receive outgoing digital data, which may be designated for different mobile stations. Thus, the outgoing digital data may include information regarding the subcarrier and the modulation type to be used for transmission, as well as other relevant information. The encoder 102 is configured to encode the outgoing data into encoded data using a predetermined coding technique, such as convolution coding or turbo coding with a predefined coding rate. The encoder 102 is also configured to interleave the encoded data using a predetermined interleaving technique. Encoding and interleaving techniques for OFDMA systems are well known in the art, and thus, are not described herein in detail.

The compressing and decompressing modulators 104 and 108 are configured to perform a function similar to a typical modulator in a conventional OFDMA transmitter. That is, the compressing and decompressing modulators 104 and 108 are configured to modulate the encoded data into modulation symbols using a predetermined modulation scheme, which is suitable for OFDMA systems. The modulation scheme choices are limited for a given application and/or standard. As an example, the modulation scheme choices for the mobile WiMAX standard include Quadrature Phase-shift Keying (QPSK), 16 level Quadrature Amplitude Modulation (16-QAM) and 64 level QAM (64-QAM). In this embodiment, the modulation scheme choices for the OFDMA transmitter 100 are assumed to be consistent with that of the mobile WiMAX standard. Thus, the OFDMA transmitter 100 can modulate outgoing data using QPSK, 16-QAM and 64-QAM.

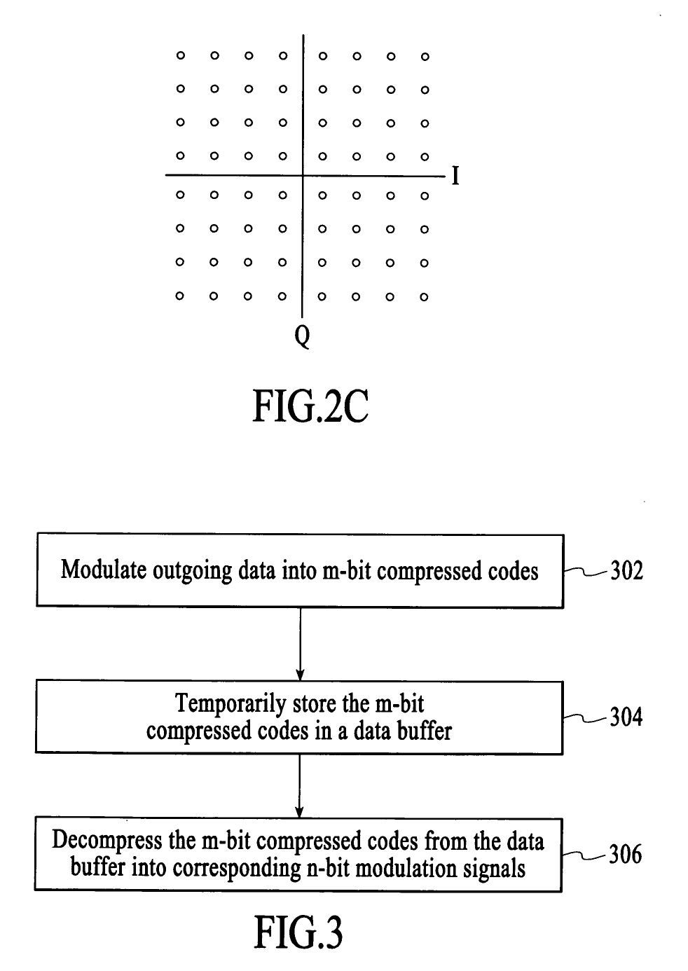

Each modulation scheme uses a distinct number of modulation symbols, which can be mapped in a constellation diagram. A constellation diagram is a diagram of a complex plane with real and imaginary axes. The real axis is commonly referred to as the in phase (I) axis. The imaginary axis is commonly referred to as the quadrature (Q) axis. Thus, each point in the constellation diagram can be represented by I and Q values. As shown in FIG. 2A, QPSK uses four modulation symbols represented by the four modulation points in the constellation diagram. As shown in FIG. 2B, 16-QAM uses sixteen modulation symbols represented by the sixteen modulation points in the constellation diagram. As shown in FIG. 2C, 64-QAM uses sixty-four modulation symbols represented by the sixty-four modulation points in the constellation diagram.

Since the OFDMA transmitter 100 uses QPSK, 16-QAM and 64-QAM, the OFDMA transmitter 100 is configured to modulate outgoing data using eighty-four modulation symbols, which is the combined total of possible modulation symbols for QPSK, 16-QAM and 64-QAM. Thus, the OFDMA transmitter 100 needs to be able to generate fourteen modulation values for I and Q independently. Each I or Q value is digitally represented by an n-bit modulation signal, where n is determined by the desired resolution of the time domain waveform to be generated for wireless transmission.

In a conventional OFDMA transmitter, outgoing encoded data is modulated into I and Q signals of different modulation symbols, and then subcarrier-mapped to a data buffer before being transmitted to an inverse fast Fourier transformer. The size of the data buffer must be at least N×M×2L, where N is the number of FFT points, M is the number of OFDMA modulation symbols and L is the size of I or Q signals of each OFDMA modulation symbol. Since both the I and Q signals for each OFDMA are stored in the data buffer, there is a factor of 2 for L.

In the OFDMA transmitter 100, however, the outgoing encoded data is first modulated into compressed modulation codes that represent I and Q signals of different modulation symbols. The compressed modulation codes are then subcarrier-mapped to the data buffer 106. After the compressed modulation codes have been subcarrier-mapped, all of the compressed modulation codes in the data buffer 106 are decompressed or expanded to the appropriate modulation values as the compressed codes are being transmitted to the inverse fast Fourier transformer 110. In a particular implementation, the compressed modulation codes are 4-bits long and the modulation values are 10-bits long. Since the minimum size of a data buffer in an OFDMA transmitter is partially dependent on the size of the I and Q signals stored in the data buffer, the data buffer 106 of the OFDMA transmitter 100 can be significantly smaller in size than a data buffer of a conventional OFDMA transmitter because the OFDMA transmitter 100 stores smaller I and Q signals (compressed modulation signals) in the data buffer 106. In the implementation where the compressed modulation signals are 4-bits long and the modulation values are 10-bits long, the data buffer 106 can be approximately sixty percent (60%) smaller than data buffers in comparable conventional OFDMA transmitters that modulate outgoing data into 10-bit modulation signals.

The compressing modulator 104 of the OFDMA transmitter 100 is connected to the encoder 102 to receive the encoded and interleaved data. The compressing modulator 104 is configured to modulate the encoded and interleaved data into m-bit compressed modulation codes, where m is less than n. The m-bit compressed codes represent I and Q values of the OFDMA symbols according to a predefined correlation. The compressing modulator 104 is also configured to compress pilot and preamble signals into corresponding m-bit compressed codes. The exact value of m depends on the number of possible modulation values, including pilot and preamble modulation values.

In an implementation, the compressing modulator 104 modulates the encoded and interleaved data according to the following table.

| Modulation Type | Compressed Code |
|---|---|
| Zero | 0000 |
| One | 0001 |
| QPSK: 0 | 0010 |
| QPSK: 1 | 0011 |
| 16QAM: 01 | 0100 |
| 16QAM: 00 | 0101 |
| 16QAM: 10 | 0110 |
| 16QAM: 11 | 0111 |
| 64QAM: 011 | 1000 |
| 64QAM: 010 | 1001 |
| 64QAM: 000 | 1010 |
| 64QAM: 001 | 1011 |
| 64QAM: 101 | 1100 |
| 64QAM: 100 | 1101 |
| 64QAM: 110 | 1110 |
| 64QAM: 111 | 1111 |

Using the above table, the compressing modulator 104 compresses I and Q signals independently into the corresponding m-bit compressed codes. In this implementation, the I signal of the pilot and preamble is mapped to “One”, which is represented by the compressed modulation code “0001”, and the Q signal of the pilot and preamble is mapped to “Zero”, which is represented by the compressed modulation code “0000”. The compressed codes are then subcarrier-mapped to the data buffer 106, which can be significantly smaller than the data buffer of a comparable conventional OFDMA transmitter due to the smaller size of the m-bit compressed codes as compared to n-bit modulation values that are stored in the conventional data buffer.

After all the outgoing data for a predefined time frame has been subcarrier-mapped to the data buffer 106, the m-bit compressed codes are transmitted to the inverse fast Fourier transformer 110 via the decompressing modulator 108. The decompressing modulator 108 is configured to decompress or expand the m-bit compressed codes into the corresponding n-bit modulation signals, which represent I and Q values of the modulation symbols. As an example, the decompressing modulator 108 can derive the corresponding n-bit modulation signals for the m-bit compressed codes using a look-up table 112.

In an implementation, the decompressing modulator 108 decompresses the m-bit compressed codes into the corresponding modulation values according to the following table.

| Compressed Code | Modulation Value |
|---|---|
| 0000 | 0 |
| 0001 | 1 |
| 0010 | 1/sqrt(2) |
| 0011 | −1/sqrt(2) |
| 0100 | 3/sqrt(10) |
| 0101 | 1/sqrt(10) |
| 0110 | −1/sqrt(10) |
| 0111 | −3/sqrt(10) |
| 1000 | 7/sqrt(42) |
| 1001 | 5/sqrt(42) |
| 1010 | 3/sqrt(42) |
| 1011 | 1/sqrt(42) |
| 1100 | −1/sqrt(42) |
| 1101 | −3/sqrt(42) |
| 1110 | −5/sqrt(42) |
| 1111 | −7/sqrt(42) |

Using the above table, the decompressing modulator 108 can decompress the m-bit compressed codes into the corresponding modulation values represented by n-bit modulation signals. The decompressing modulator 108 performs the decompressing of the m-bit compressed codes as the m-bit compressed codes for different subcarriers are being transmitted to the inverse fast Fourier transformer 110. The inverse fast Fourier transformer 110 is configured to performed inverse fast Fourier transform on the n-bit modulation signals from the decompressing modulator 108 to generate time domain waveform for wireless transmission.

The encoder 102, the compressing modulator 104, the decompressing modulator 108 and the inverse fast Fourier transformer 110 of the OFDMA transmitter 100 represent functional blocks that can be implemented in any combination of software, hardware and firmware. In addition, some of these components of the OFDMA transmitter 100 may be combined or divided so the OFDMA transmitter 100 includes fewer or more components than described and illustrated herein.

A method of transmitting OFDMA signals in accordance with an embodiment of the invention will be described with reference to a flow diagram of FIG. 3. At block 302, outgoing data is modulated into m-bit compressed codes. Some of these m-bit compressed code represent OFDMA modulation symbols. Next, at block 304, the m-bit compressed codes are temporarily stored in a data buffer. Next, at block 306, the m-bit compressed codes from the data buffer are decompressed into corresponding n-bit modulation signals, where n is greater than m. Some of the n-bit modulation signals are digital values of the OFDMA modulation symbols. The n-bit modulation signals are used to produce time domain waveform for wireless transmission.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. An Orthogonal Frequency Division Multiple Access (OFDMA) transmitter comprising:
a compressing modulator configured to modulate outgoing data into m-bit compressed codes, some of said m-bit compressed codes representing OFDMA modulation symbols;
a data buffer configured to temporarily store said m-bit compressed codes; and
a decompressing modulator configured to decompress said m-bit compressed codes from said data buffer into corresponding n-bit modulation signals, where n is greater than m, some of said n-bit modulation signals being digital values of said OFDMA modulation symbols, said n-bit modulation signals being used to produce time domain waveform for wireless transmission.

2. The transmitter of claim 1 further comprising an encoder configured to encode said outgoing data before being transmitted to said compressing modulator.

3. The transmitter of claim 1 further comprising an inverse fast Fourier transformer configured to perform inverse fast Fourier transform on said n-bit modulation signals from said decompressing modulator.

4. The transmitter of claim 1 wherein said compressing modulator is configured to modulate said outgoing data into said m-bit compressed codes that represent modulation symbols of a modulation scheme selected from a group consisting of Quadrature Phase-shift Keying (QPSK) and Quadrature Amplitude Modulation.

5. The transmitter of claim 1 wherein said compressing modulator is configured to modulate said outgoing data into said m-bit compressed codes that represent modulation symbols of QPSK, 16-QAM and 64-QAM.

6. The transmitter of claim 1 wherein said compressing modulator is configured to modulate said outgoing data into 4-bit compressed codes and wherein said decompressing modulator is configured to decompress said 4-bit compressed codes into corresponding 10-bit modulation signals.

7. The transmitter of claim 1 wherein said compressing modulator is configured to modulate a pilot signal and a preamble signal associated with said outgoing data into some of said m-bit compressed codes.

8. The transmitter of claim 1 wherein said compressing modulator is configured to modulate said outgoing data into said m-bit compressed codes that represent I and Q values of said OFMDA modulation symbols.

9. An Orthogonal Frequency Division Multiple Access (OFDMA) transmitter comprising:
an encoder configured to encode outgoing data into encoded data;
a compressing modulator configured to modulate said encoded data into m-bit compressed codes, some of said m-bit compressed codes representing OFDMA modulation symbols;
a data buffer configured to temporarily store said m-bit compressed codes;
a decompressing modulator configured to decompress said m-bit compressed codes from said data buffer into corresponding n-bit modulation signals, where n is greater than m, some of said n-bit modulation signals being digital values of said OFDMA modulation symbols; and
an inverse fast Fourier transformer configured to perform inverse fast Fourier transform on said n-bit modulation signals to produce time domain waveform for wireless transmission.

10. The transmitter of claim 9 wherein said compressing modulator is configured to modulate said encoded data into said m-bit compressed codes that represent modulation symbols of a modulation scheme selected from a group consisting of Quadrature Phase-shift Keying (QPSK) and Quadrature Amplitude Modulation.

11. The transmitter of claim 9 wherein said compressing modulator is configured to modulate said encoded data into said m-bit compressed codes that represent modulation symbols of QPSK, 16-QAM and 64-QAM.

12. The transmitter of claim 9 wherein said compressing modulator is configured to modulate said encoded data into 4-bit compressed codes and wherein said decompressing modulator is configured to decompress said 4-bit compressed codes into corresponding 10-bit modulation signals.

13. The transmitter of claim 9 wherein said compressing modulator is configured to modulate a pilot signal and a preamble signal associated with said encoded data into some of said m-bit compressed codes.

14. A method of transmitting Orthogonal Frequency Division Multiple Access (OFDMA) signals, said method comprising:
modulating outgoing data into m-bit compressed codes, some of said m-bit compressed codes representing OFDMA modulation symbols;
temporarily storing said m-bit compressed codes in a data buffer; and
decompressing said m-bit compressed codes from said data buffer into corresponding n-bit modulation signals, where n is greater than m, some of said n-bit modulation signals being digital values of said OFDMA modulation symbols, said n-bit modulation signals being used to produce time domain waveform for wireless transmission.

15. The method of claim 14 further comprising encoding said outgoing data before executing said modulating.

16. The method of claim 14 further comprising performing an inverse fast Fourier transform (IFFT) on said n-bit modulation signal.

17. The method of claim 14 wherein said modulating includes modulating said outgoing data into said m-bit compressed codes that represent modulation symbols of a modulation scheme selected from a group consisting of Quadrature Phase-shift Keying (QPSK) and Quadrature Amplitude Modulation.

18. The method of claim 14 wherein said modulating includes modulating said outgoing data into said m-bit compressed codes that represent modulation symbols of QPSK, 16-QAM and 64-QAM.

19. The method of claim 14 wherein said modulating includes modulating said outgoing data into 4-bit compressed codes and wherein said decompressing includes decompressing said 4-bit compressed codes into corresponding 10-bit modulation signals.

20. The method of claim 14 wherein said modulating includes modulating said outgoing data into said m-bit compressed codes that represent I and Q values of said OFDMA modulation symbols.
